(19) United States
(12) Patent Application Publication
(10) Pub. No.: US 2026/0268875 A1
(43) Pub. Date: Sep. 10, 2026

(54) METHOD FOR CONTROLLING TRANSMISSION AND RECEPTION, AND DISPLAY DRIVER USING SAME

(71) Applicant: LX Semicon Co., Ltd., Daejeon (KR)

(72) Inventors: Jeong Ho PARK, Daejeon (KR); Myung Yu KIM, Daejeon (KR); Jong Jin YANG, Daejeon (KR)

(73) Assignee: LX Semicon Co., Ltd., Daejeon (KR)

(21) Appl. No.: 19/166,777

(22) PCT Filed: Mar. 21, 2024
(86) PCT No.: PCT/KR2024/003556

§ 371 Date: Sep. 18, 2025

(30) Foreign Application Priority Data
Mar. 22, 2023 (KR) 10-2023-0037618
Mar. 20, 2024 (KR) 10-2024-0038736

(51) Int. Cl. G09G 5/12; G09G 3/3266

(52) U.S. Cl. CPC G09G 5/12; G09G 3/3266; G09G 2330/10

(57) ABSTRACT

The present disclosure relates to a transmission and reception control method and a display driver using the same. The transmission and reception control method may include a step in which, in a first mode, after a first interrupt signal is received from a reception device, a transmission device transmits an image signal to the reception device together with a synchronization signal, and in a second mode, after a second interrupt signal is received from the reception device, the transmission device transmits an image signal to the reception device without a synchronization signal. At least one of the first interrupt signal and the second interrupt signal includes panel information to be applied to pixel data of the image signal.

### TECHNICAL FIELD

The present disclosure relates to a method for controlling transmission and reception, and display driver using same.

### BACKGROUND ART

There are known various display devices such as liquid crystal devices (LCDs), electroluminescence displays (ELDs) such as organic light-emitting diode (OELD) displays, field emission displays (FEDs), and plasma display panels (PDPs). Such display devices may visually reproduce, on a display panel, image signals received from a host system through a high-speed interface.

Recently, in order to reduce power consumption of a display device, a frame frequency or a refresh rate of an image signal may be lowered under certain conditions. When the refresh rate is lowered, an asynchronization problem between a transmission-side circuit and a reception-side circuit of a high-speed interface may become serious. This may result in deterioration of image quality such as missing frames in an image reproduced on a display panel.

### DISCLOSURE

### Technical Problem

The present disclosure provides a transmission and reception control method capable of solving an asynchronization problem between a host system and a display driver when a refresh rate is lowered in a high-speed interface that supports a variable refresh rate, and a display driver using the same.

### Technical Solution

A transmission and reception control method according to an embodiment of the present disclosure includes: a step in which, in a first mode, after a first interrupt signal is received from a reception device, a transmission device transmits an image signal to the reception device together with a synchronization signal, and a step in which, in a second mode, after a second interrupt signal is received from the reception device, the transmission device transmits an image signal to the reception device without a synchronization signal. At least one of the first interrupt signal and the second interrupt signal includes panel information to be applied to pixel data of the image signal.

The panel information may include one or more information of a compensation value to be applied to the pixel data of the image signal, location information of a defective subpixel, a refresh rate of a display panel, a bandwidth of the image signal, an interrupt signal period, and the number of pixel lines of the display panel.

The transmission and reception control method may further include a step in which, in the first mode, the transmission device waits in a non-driving state during a vertical blank period until the first interrupt signal is detected, and wakes up and transmits next frame data to the reception device when the first interrupt signal is detected, and a step in which, in the second mode, a synchronization signal is generated inside the reception device.

At least one of the first interrupt signal and the second interrupt signal may include at least one of a header part and a tail part. At least one of the header part and the tail part may include a pulse toggled at a cycle of n (n is a positive integer) horizontal period and having a pulse width of n horizontal period, or two or more impulses generated at a cycle of n horizontal period.

At least one of the first interrupt signal and the second interrupt signal may include the header part, an information section in which the panel information is encoded, and the tail part. An interrupt signal period during which at least one of the first interrupt signal and the second interrupt signal is transmitted to the transmission device may include a first period during which the header part is transmitted to the transmission device; a second period during which the information section is transmitted to the transmission device; and a third period during which the tail part is transmitted to the transmission device.

At least one of the first interrupt signal and the second interrupt signal may include a first header part toggled at a cycle of n (n is a positive integer) horizontal period; a second header part comprising information on an information section in which the panel information is encoded; a first tail part comprising an error check code; and a second tail part toggled at a cycle of n horizontal period. An interrupt signal period during which at least one of the first interrupt signal and the second interrupt signal is transmitted to the transmission device may include a 1-1th period during which the first header part is transmitted to the transmission device; a 1-2th period during which the second header part is transmitted to the transmission device; a second period during which the information section in which the panel information is encoded is transmitted to the transmission device; a 3-1 th period during which the first tail part is transmitted to the transmission device; and 3/36 a 3-2th period during which the second tail part is transmitted to the transmission device.

The first mode may be a video mode of a mobile industry processor interface (MIPI). The second mode may be a command mode of the MIPI. The transmission device may include one of a system on chip (SoC), an application processor (AP), and a graphics processing part (GPU). The reception device may include a display driver that outputs data of the image signal and outputs a display timing signal.

A display driver according to an embodiment of the present disclosure includes an interrupt signal generation part that transmits an interrupt signal to a host processor through an interrupt signal line within a vertical blank period in each of a first mode and a second mode; a reception part that receives data of an image signal from the host processor through a data lane together with a synchronization signal in the first mode, and receives the data of the image signal through the data lane without the synchronization signal in the second mode; and a display control part that generates a display timing signal based on the synchronization signal received from the host processor and outputs the data of the image signal in the first mode, and generates the display timing signal based on an internally generated synchronization signal and outputs the data of the image signal in the second mode. The interrupt signal includes panel information to be applied to pixel data of the image signal.

### Advantageous Effects

According to an embodiment of the present disclosure, a transmission and reception control method can reduce power consumption by supporting a variable refresh rate, and prevent an asynchronization problem between a display driver and a host processor by transmitting an interrupt signal to the host processor in a non-driving state during a vertical blank period.

According to an embodiment of the present disclosure, a host processor waits in a non-driving state during a vertical blank period and consumes no power, and a display driver transmits an interrupt signal to the host processor during the vertical blank period to induce wake-up of the host processor, thereby accurately synchronizing the host processor and the display driver.

According to an embodiment of the present disclosure, since an interrupt signal output from a display driver is toggled at a predetermined cycle or includes an impulse generated at a predetermined cycle, a process in which a host processor trims or calibrates a clock for synchronization with the display driver can be reduced or minimized.

According to an embodiment of the present disclosure, the refresh rate of pixels is lowered, so that power consumption of a system including a display device can be improved and a display driver can receive an image signal without missing the image signal.

According to an embodiment of the present disclosure, by transmitting panel information to a host processor, communication stability of an image signal generated from the host processor can be secured and the quality of an image reproduced on a display panel can be improved.

The effects of the present disclosure are not limited to those mentioned above and other unmentioned effects will be clearly understood by those skilled in the art from the following description.

### Description of Drawings

FIG. 1 is a diagram showing a transmission and reception device according to an embodiment of the present disclosure;

FIG. 2 is a flow chart showing a transmission and reception control method according to an embodiment of the present disclosure;

FIG. 3 is a diagram showing input and output signals of a display driver in a command mode of a transmission and reception control method according to an embodiment of the present disclosure;

FIG. 4 is a diagram showing input and output signals of a display driver in a video mode of a transmission and reception control method according to an embodiment of the present disclosure;

FIG. 5 is a waveform diagram showing an interrupt signal according to an embodiment of the present disclosure;

FIG. 6 is a detailed waveform diagram showing an interrupt signal period shown in FIG. 5;

FIG. 7 is a diagram showing operations in each duration of a display driver and a host processor during an interrupt signal period in FIG. 5;

FIG. 8 is a waveform diagram showing an interrupt signal according to another embodiment of the present disclosure;

FIG. 9 is a detailed waveform diagram showing an interrupt signal period shown in FIG. 8; and

FIG. 10 is a diagram showing a display device according to an embodiment of the present disclosure.

### BEST MODEL

A transmission and reception control method according to an embodiment of the present disclosure includes: a step in which, in a first mode, after a first interrupt signal is received from a reception device, a transmission device transmits an image signal to the reception device together with a synchronization signal, and a step in which, in a second mode, after a second interrupt signal is received from the reception device, the transmission device transmits an image signal to the reception device without a synchronization signal. At least one of the first interrupt signal and the second interrupt signal includes panel information to be applied to pixel data of the image signal.

### Mode for Invention

The advantages and features of the present disclosure and methods for accomplishing the same will be more clearly understood from embodiments described below with reference to the accompanying drawings. However, the present disclosure is not limited to the following embodiments but may be implemented in various different forms. Rather, the present embodiments will make the disclosure of the present disclosure complete and allow those skilled in the art to completely comprehend the scope of the present disclosure. The present disclosure is only defined within the scope of the accompanying claims.

The shapes, sizes, ratios, angles, numbers, and the like illustrated in the accompanying drawings for describing the embodiments of the present disclosure are merely examples, and the present disclosure is not limited thereto. Like reference numerals generally denote like elements throughout the present specification. Further, in describing the present disclosure, detailed descriptions of known related technologies may be omitted to avoid unnecessarily obscuring the subject matter of the present disclosure.

The terms such as “comprising,” “including,” “having,” and “comprising” used herein are generally intended to allow other components to be added unless the terms are used with the term “only.” Any references to singular may include plural unless expressly stated otherwise.

Components are interpreted to include an ordinary error range even if not expressly stated.

When a positional or interconnected relationship is described between two components, such as “on top of,” “above,” “below,” “next to,” “connect or couple with,” “crossing,” “intersecting,” or the like, one or more other components may be interposed between them, unless “immediately” or “directly” is used.

When a temporal antecedent relationship is described, such as “after”, “following”, “next to”, “before”, or the like, it may not be continuous on a time base unless “immediately” or “directly” is used.

The terms “first,” “second,” and the like may be used to distinguish elements from each other, but the functions or structures of the components are not limited by ordinal numbers or component names in front of the components.

The following embodiments can be partially or entirely bonded to or combined with each other and can be linked and operated in technically various ways. The embodiments can be carried out independently of or in association with each other.

Various embodiments of the present disclosure will be described below with reference to the accompanying drawings.

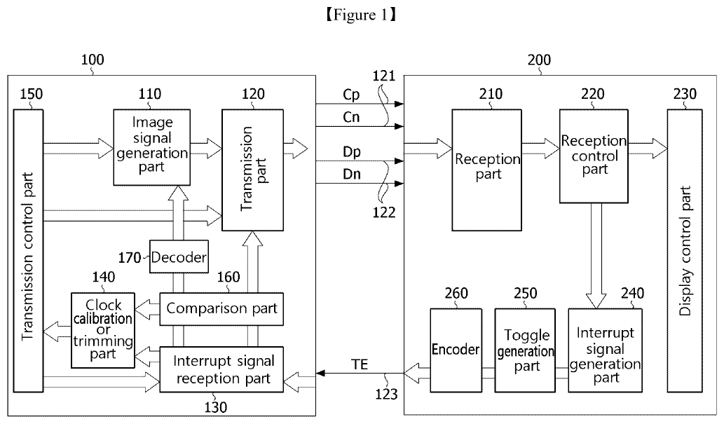

FIG. 1 is a diagram showing a transmission and reception device according to an embodiment of the present disclosure.

Referring to FIG. 1, the transmission and reception device includes a transmission device 100 and a reception device 200.

The transmission device 100 and the reception device 200 are connected to each other through a digital high-speed interface including a clock lane 121, a data lane 122, and an interrupt signal line 123, for example, a mobile industry processor interface (MIPI). The MIPI is a standard interface established by an MIPI Alliance. Although one data lane 122 is shown in FIG. 1, the present disclosure is not limited thereto. Two or more data lanes 122 through which image signals are respectively transmitted may be connected between the transmission device 100 and the reception device 200.

The transmission device 100 may transmit pixel data of an image signal and a clock signal to the reception device 200 through the digital high-speed interface. The clock signal may be transmitted to the reception device 200 through the clock lane 121 in the form of a differential signal including a positive polarity clock Cp and a negative polarity clock Cn. The input image signal may be transmitted to the reception device 200 through the data lane 122 in the form of a differential signal including positive polarity pixel data Dp and negative polarity pixel data Dn. An interrupt signal TE may be output from the reception device 200 in the form of a low-voltage digital signal or an impulse and transmitted to the transmission device 100. In the MIPI, the interrupt signal TE may be a tearing effect (TE), but is not limited thereto.

Hereinafter, the “transmission device” and the “reception device” will be referred to as a “host processor” and a “display driver,” respectively.

The host processor 100 may be one of a system on chip (SoC), an application processor (AP), and a graphics processing unit (GPU), which allow an image signal to be output by a host system such as a mobile device, a video phone, a smart watch, a watch phone, a wearable apparatus, an electronic notebook, an electronic book, a portable multimedia player (PMP), a personal digital assistant (PDA), an MP3 player, a mobile medical device, a desktop PC, a laptop PC, a netbook computer, a workstation, a navigation, a vehicle display device, a theater display device, a television, a wallpaper device, a signage device, a game device, a notebook computer, a monitor, a camera, a camcorder, and a home appliance, but is not limited thereto.

An MIPI display serial interface (DSI)-2 v2.0 may support a variable refresh rate (VRR) or an adaptive refresh panel (ARP) to improve power consumption of electronic devices to which the transmission and reception device is applied. The host processor 100 transmits frame data of an input image to the display driver 200 every frame period in a normal operation mode. 1 frame data includes pixel data for 1 frame written in all pixels of a screen or a display area of a display panel.

The host processor 100 may analyze the input image, lower a refresh rate in a still image or an always on display (AOD) screen where the input image does not change for a preset time, enter a low-power mode with almost no power consumption during an extended vertical blank period, and wait in the low-power mode until an interrupt signal is received. The AOD screen may be a portion of a pixel area of a display panel where preset information, for example, brief information such as remaining battery and time, is displayed when the host processor 100 waits in the low-power mode. In the low-power mode, the host processor 100 may consume little power by turning off power to other circuits except for circuits that respond to the interrupt signal.

1 (one) frame period may be divided into an active interval in which pixel data of an image signal exists and a vertical blank period in which there is no image signal between frame periods. As the refresh rate of pixels is lowered, the vertical blank period may become longer.

When an interrupt signal output from the display driver 200 is detected in the host processor 100, the host processor 100 may wake up and re-enter a normal driving mode. In the normal driving mode, the host processor 100 transmits next frame data of an image signal to the display driver 200 and then transmits frame data of an input image every frame period.

The host processor 100 includes a transmission control part 150, an image signal generation part 110, a transmission part 120, an interrupt signal reception part 130, a comparison part 160, a decoder 170, and a clock calibration or trimming part 140.

When the interrupt signal TE received from the display driver 200 is detected, the interrupt signal reception part 130 counts the pulse width of the interrupt signal TE with an internal clock (hereinafter, referred to as “first clock”) generated from an internal oscillator of the host processor 100. After the interrupt signal TE is detected, the interrupt signal reception part 130 provides the decoder 170 with panel information received from the display driver 200. The panel information may include a compensation value to be applied to pixel data of an image signal, location information of a defective subpixel, and the like. The panel information may further include information such as a refresh rate currently applied to the display panel, a bandwidth of an image signal transmitted to the display driver 200, an interrupt signal period, and the number of pixel lines (or horizontal lines) of the display panel.

The transmission control part 150 may determine 1 horizontal period of the display driver 200 based on the pulse width count value of the interrupt signal TE. The pulse width count value of the interrupt signal TE indicates the pulse width of the interrupt signal TE. The transmission control part 150 may control the clock calibration or trimming part 140 to trim or calibrate the first clock generated from the internal oscillator, thereby synchronizing 1 horizontal period of the host processor 100 with 1 horizontal period of the display driver 200.

The comparison part 160 may compare the pulse width count value of the interrupt signal TE with a specific value, and control the clock calibration or trimming part 140 to trim or calibrate the first clock, thereby controlling a frequency of the first clock to be equal to or similar to a frequency of the second clock generated in the display driver 200. The specific value may be the total number of horizontal periods within 1 frame period. The comparison part 160 may control the clock calibration or trimming part 140 to compare a pulse width of a currently detected interrupt signal TE with a previously accumulated or previously detected interrupt signal TE, thereby trimming or calibrating the first clock of the interrupt signal TE so that an error between the two interrupt signals TE is managed below ±1%.

The transmission control part 150 may determine 1 frame period and 1 horizontal period of the display driver 200 by checking the toggle count of the accumulated interrupt signals TE. Since the transmission control part 150 compares the frame period and the horizontal period of the display driver 200 with an accumulated value or a previous value, the transmission control part 150 may control the frame period and the horizontal period of the host processor 100 to be the same as those of the display driver 200 every horizontal period even though the pulse width of the interrupt signal TE is longer than 1 horizontal period.

The transmission control part 150 may count the horizontal period with the first clock input through the clock calibration or trimming part 140, and determine an active interval in which pixel data of an image signal exists in 1 frame period and a vertical blank period in which there is no image signal between frame periods. The transmission control part 150 may generate a synchronization signal that is synchronized with the pixel data of the image signal, for example, a vertical synchronization signal, and control the operation timing of each of the image signal generation part 110, the transmission part 120, and the interrupt signal reception part 130.

The clock calibration or trimming part 140 may trim or calibrate the pulse of the interrupt signal input through the interrupt signal reception part 130 and the first clock based on the comparison result input from the comparison part 160, thereby synchronizing clocks between the host processor 100 and the display driver 200. The transmission control part 150 may count 1 horizontal period with a clock calibrated by the clock calibration or trimming part 140 and control 1 horizontal period of the host processor 100 to be equal to 1 horizontal period of the display driver 200.

The decoder 170 decodes the panel information received through the interrupt signal reception part 130 to restore the panel information, and provides the restored panel information to the image signal generation part 110. As described above, the panel information includes one or more information of the compensation value to be applied to the pixel data of the image signal, the location information of the defective subpixel, the refresh rate of the display panel, the bandwidth, the interrupt signal period, and the number of pixel lines (or horizontal lines) of the display panel.

The image signal generation part 110 generates the pixel data of the image signal under the control of the transmission control part 150. The image signal generation part 110 may align and scale next frame data of the image signal based on the resolution of the display panel and the panel information received from the display driver 200, and convert the scaled data into data in a data transmission packet format satisfying the MIPI standard. In such a case, a compensation value may be applied to each pixel data of the next frame data according to the panel information, so that a pixel data value may be modulated and a pixel data value to be written to a defective pixel may be reflected in surrounding normal pixel data.

The image signal generation part 110 may encode or pack synchronization signal data, for example, a vertical synchronization signal, into the image signal under the control of the transmission control part 150. The transmission part 120 may convert the pixel data of the image signal and a clock into a differential signal under the control of the transmission control part 150, and transmit the differential signal to the display driver 200 through the clock lane 121 and the data lane 122. The image signal generation part 110 and the transmission part 120 may each include a memory for storing the pixel data of the image signal. The signal transmitted to the display driver 200 through the data lane 122 may include the pixel data of the image signal in a command mode, and may include the pixel data of the image signal and the synchronization signal data in a video mode.

The display driver 200 includes a reception part 210, a reception control part 220, a display control part 230, an interrupt signal generation part 240, a toggle generation part 250, and an encoder 260.

The reception part 210 may receive the data of the image signal from the host processor 100 together with the synchronization signal through the data lane 122 in the video mode, and receive the data of the image signal from the host processor 100 without the synchronization signal through the data lane 122 in the command mode. The reception part 210 may receive a clock synchronized with the pixel data of the image signal through the clock lane 121, and receive the pixel data of the image signal and the synchronization signal through the data lane 122. The reception control part 220 may transmit the pixel data of the image signal and the synchronization signal to the display control part 230, and control the operation timings of the display control part 230 and the interrupt signal generation part 240 by using the synchronization signal.

The display control part 230 may convert the pixel data of the image signal input from the reception control part 220 into a data voltage, output the data voltage, and generate a display timing signal. The display timing signal may include a source timing signal for controlling the operation timing of a data driver that outputs the data voltage, and a gate timing signal for controlling the operation timing of a gate driver that supplies a gate signal to gate lines of the display panel.

The interrupt signal generation part 240 may generate and output the interrupt signal TE under the control of the reception control part 220 in each of the video mode and the command mode. The interrupt signal TE may be transmitted to the host processor 100 through the interrupt signal line 123.

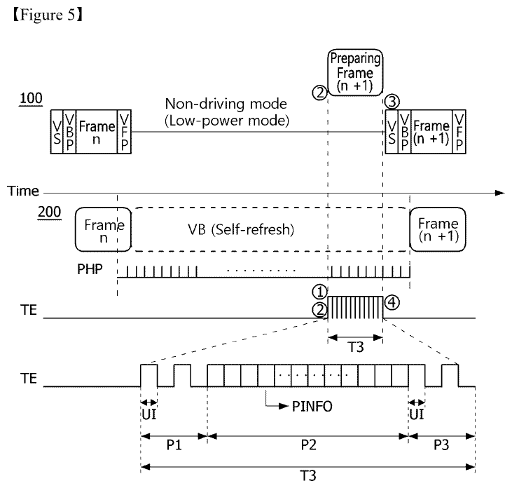

During the interrupt signal period, the toggle generation part 250 may toggle the interrupt signal TE two or more times, for example, one or more of a header part and a tail part thereof. When the interrupt signal period is too long, a variation error between the oscillator of the host processor 100 and the oscillator of the display driver 200 may increase. The interrupt signal period may be set to a time within 1 frame period, and an error range of 0.1% to 10% compared to the total horizontal period of 1 frame period may be allowed. A period during which the interrupt signal TE is generated may be ‘T3’ in FIGS. 5 to 9.

When the interrupt signal TE is toggled, a voltage level or a logic value of the interrupt signal TE is inverted from a high level to a low level or from a low level to a high level. The toggle generation part 250 may toggle the interrupt signal TE for a predetermined period, for example, at a cycle of n (n is a positive integer) horizontal period during the interrupt signal period. The n horizontal period may be a time equal to or less than ¼ frame period, for example, 1 horizontal period, 2 horizontal period, 3 horizontal period, 4 horizontal period, or the like. The interrupt signal TE may include two or more impulses generated within the interrupt signal period and generated at a cycle of n horizontal period.

When the display driver 200 transmits the interrupt signal TE to the host processor 100 as a pulse of n horizontal period, the host processor 100 may count 1 horizontal period synchronized with 1 horizontal period of the display driver 200 in response to the pulse or impulse of the interrupt signal TE. In such a case, clock trimming or calibration for reducing an oscillator variation difference between the host processor 100 and the display driver 200 may be reduced or eliminated. For example, when the pulse of the interrupt signal TE is generated with a pulse width of 1 horizontal period or the impulse of the interrupt signal TE is generated at a cycle of 1 horizontal period, the host processor 100 may set the pulse with or impulse cycle of the received interrupt signal TE to 1 horizontal period as is. In such a case, no separate clock trimming or calibration is required within the host processor 100 for synchronization with the display driver 200.

The encoder 260 encodes the panel information including one or more information of the compensation value to be applied to the pixel data of the image signal, the location information of the defective subpixel, the refresh rate of the display panel, the bandwidth, the interrupt signal period, and the number of pixel lines (or horizontal lines) of the display panel, into the interrupt signal TE. The interrupt signal TE including the panel information is transmitted to the host processor 100 by the encoder 260.

The high-speed interface of the present disclosure may support a command mode and a video mode published as a standard for the mobile industry processor interface (MIPI). The host processor 100 may transmit a mode signal with different data values in the command mode and the video mode to the display driver 200 through the data lane 122, thereby controlling the display driver 200 in the command mode or the video mode.

A transmission and reception control method of the present disclosure causes the display driver 200 to generate, as the interrupt signal, horizontal period information of 1 frame period required for driving pixels of the display panel, and to transmit the interrupt signal to the host processor 100. The host processor 100 may consume no power by waiting in a non-driving state (or low power mode) during an extended vertical blank period at a low refresh rate, and prepare to generate and transmit next frame data in a horizontal period synchronized with the display driver 200 in response to the pulse or impulse of the interrupt signal TE received from the display driver 200 in the non-driving state. Accordingly, even though the host processor 100 waits for a long time in the non-driving state, since next frame data of an image signal is transmitted from the host processor 100 to the display driver 200 in the state in which the host processor 100 and the display driver 200 are synchronized with each other, image quality degradation or frame data missing does not occur when the image signal is reproduced on the display panel.

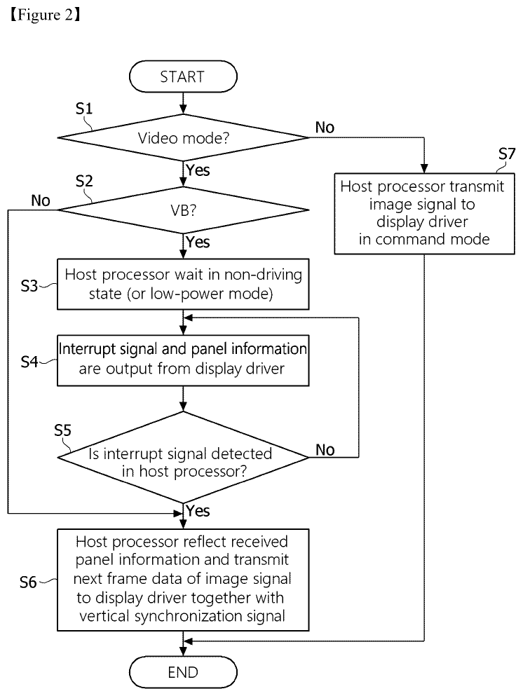

FIG. 2 is a flowchart showing a transmission and reception control method according to an embodiment of the present disclosure.

Referring to FIG. 2, the display driver 200 may receive frame data of an input image from the host processor 100 during an active interval of a frame period in the video mode (or first mode) (S1). The host processor 100 may transmit the frame data of the image signal to the display driver 200 in the command mode (or second mode) (S7).

In the video mode, the host processor 100 waits in a non-driving state (or low-power mode) until an interrupt signal TE is detected within a vertical blank period and outputs no image signal (S2 and S3). Accordingly, the display driver 200 does not receive the frame data of the input image during the vertical blank period in the video mode.

In the video mode, as the vertical blank period becomes longer, an asynchronization time difference between the host processor 100 and the display driver 200 may increase. In order to prevent such a problem, the display driver 200 transmits the pulse or impulse of the interrupt signal TE to the host processor 100 in an interrupt signal period set within the vertical blank period of the video mode, and transmits the panel information the host processor 100 (S4).

When the interrupt signal TE is detected in the video mode, the host processor 100 may wake up and be synchronized with the display driver 200, and transmit next frame data to the display driver 200 together with a vertical synchronization signal (S5 and S6). In step S6, the host processor 100 may generate the next frame data by applying the panel information received from the display driver 200.

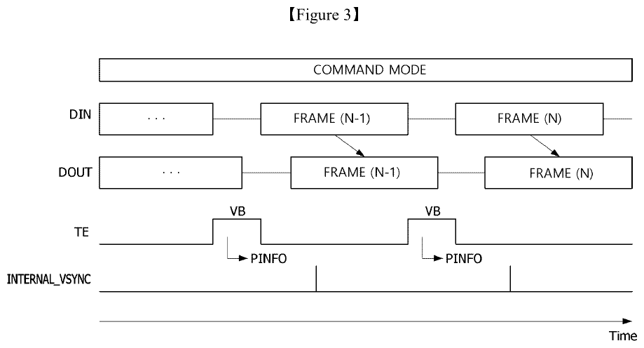

In step S7, the host processor 100 may receive the panel information from the display driver 200 during the vertical blank period in the command mode as shown in FIG. 3. In such a case, in the command mode, the host processor 100 may generate the next frame data by applying the panel information received from the display driver 200, and transmit the generated next frame data to the display driver 200.

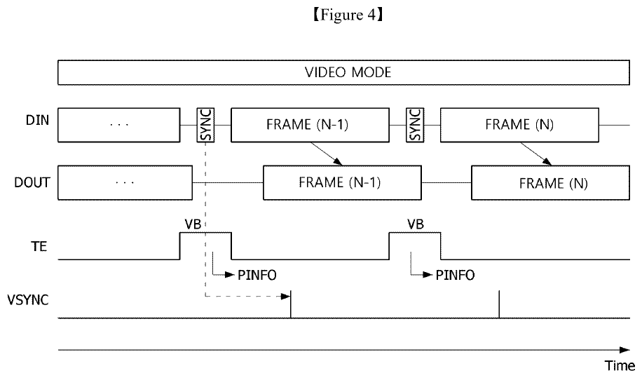

FIG. 3 is a diagram showing input and output signals of the display driver in the command mode. FIG. 4 is a diagram showing input/output signals of the display driver in the video mode. In FIGS. 3 and 4, “DIN” denotes an image signal input to the display driver 200, and “DOUT” denotes an image signal output from the display driver 200.

Referring to FIG. 3, in the command mode, the host processor 100 may transmit timing data, for example, pixel data of an image signal without a synchronization signal. In the command mode, since no timing data is received, the display driver 200 stores the pixel data of the image signal received from the host processor 100 in a frame memory in frame parts and generates a display timing signal.

In the command mode, the display driver 200 drives the pixels of the display panel by generating the display timing signal based on a second clock generated from an internal oscillator of the display driver 200. In the command mode, the display driver 200 may transmit the interrupt signal TE to the host processor 100. The interrupt signal TE may be generated within a vertical blank period VB, in which there is no pixel data of the image signal between adjacent frame periods on a time axis, for example, an N-1th (N is a positive integer) frame period and an Nth frame period, and may be transmitted to the host processor 100. The interrupt signal TE transmitted from the display driver 200 to the host processor 100 in the command mode may include panel information PINFO including one or more information of the compensation value to be applied to the pixel data of the image signal, the location information of the defective subpixel, the refresh rate of the display panel, the bandwidth, the interrupt signal period, and the number of pixel lines (or horizontal lines) of the display panel. In the command mode, the host processor 100 may transmit the next frame data of the image signal to the display driver 200 in response to the interrupt signal TE received from the display driver 200.

In FIG. 3, “INTERNAL_VSYNC” denotes a vertical synchronization signal generated in the display driver 200 in the command mode. The display driver 200 may generate the display timing signal based on the vertical synchronization signal INTERNAL_VSYNC generated by counting the second clock in the command mode and output a data voltage of pixel data.

Referring to FIG. 4, in the video mode, the host processor 100 may packet timing data, for example, at least one synchronization signal SYNC of a vertical synchronization signal, a horizontal synchronization signal, and a data enable signal, into the pixel data of the image signal, and transmit the pixel data to the display driver 200. In the video mode, since the display driver 200 may generate a display timing signal based on a timing signal received from the host processor, for example, synchronization signal data, the use of a frame memory is not essential.

In the video mode, since the display driver 200 receives the timing signal from the host processor 100, there is no need to transmit the interrupt signal TE for synchronization with the display driver 200; however, in an embodiment of the present disclosure, when the refresh rate of pixels is low in the video mode, the interrupt signal TE may be transmitted in an interrupt signal period set within the vertical blank period VB in order to prevent an asynchronization problem between the host processor 100 and the display driver 200. In the video mode, the interrupt signal TE transmitted from the display driver 200 to the host processor 100 may include the panel information PINFO including one or more information of the compensation value to be applied to the pixel data of the image signal, the location information of the defective subpixel, the refresh rate of the display panel, the bandwidth, the interrupt signal period, and the number of pixel lines (or horizontal lines) of the display panel.

In the video mode, when the refresh rate is lowered, for example, is lowered from a first refresh rate to a second refresh rate, a vertical blank period in which no image signal is input to the display driver 200 becomes longer. In the video mode, during an extended vertical blank period when the refresh rate is lowered, circuits other than an interrupt signal response circuit, for example, the interrupt signal reception part 130 waits in a low-power mode being a non-driving state in the host processor 100. Therefore, when the refresh rate is low in the video mode, an asynchronization problem may occur between the display driver 200 and the host processor 100, and as the vertical blank period becomes longer, an asynchronization error time may further increase. In order to prevent such a problem, the transmission and reception control method according to an embodiment of the present disclosure uses the interrupt signal TE in the video mode to synchronize the host processor 100, which is waiting in an unsynchronized state at a low refresh rate, with the display driver 200. The low refresh rate may be a refresh rate of a lower frequency than the highest refresh rate within a variable refresh rate range supported in the video mode, for example, a frequency of 1 Hz to 60 Hz when the highest refresh rate is 120 Hz, but is not limited thereto.

As shown in FIG. 4, there is no vertical synchronization signal INTERNAL_VSYNC generated in the display driver 200 in the video mode. The display driver 200 may generate a display timing signal by using a vertical synchronization signal VSYNC obtained by sampling the synchronization signal SYNC received from the host processor 100 in the video mode, and output a data voltage of pixel data.

When the resolution of the display panel is FHD (1920×1080), 1 frame period may be the sum of the total horizontal period of the vertical blank period and the active interval and 1111 horizontal periods. When the refresh rate is 60 Hz, 60 frame periods are allocated to 1 second. In such a case, 1 frame period is 1/60 second. The 60 frame periods are the sum of 66660 horizontal periods. When the refresh rate is lowered to 1 Hz, pixel data is written to pixels for 1 frame period corresponding to 1/60 second, and then no data is written to the pixels for the remaining 59 frame periods. Accordingly, when the refresh rate is 1 Hz, the vertical blank period extends to a time corresponding to 59 frame periods and is the sum of 65549 horizontal periods. When the refresh rate is lowered to 1 Hz, the pixels may be self-refreshed with a data voltage stored in a storage capacitor without being charged with a new data voltage during the vertical blank period.

The horizontal period within the vertical blank period may be counted as a clock independently generated in the host processor 100 and the display driver 200. An output variation may occur between an oscillator that generates the first clock in the host processor 100 and an oscillator that generates the second clock in the display driver 200. When a variation is assumed to be is ±5% in the oscillator of each of the host processor 100 and the display driver 200, a maximum error of 10% may occur between a horizontal period counted by the host processor 100 and a horizontal period counted by the display driver 200. In such a case, when the refresh rate is 1Hz, the extended vertical blank period may be the time between 58994 horizontal periods and 72103 horizontal periods.

In order to prevent an increase in an error in a horizontal period count value between the host processor 100 and the display driver 200, the display driver 200 may transmit the interrupt signal TE to the host processor 100 during the vertical blank period.

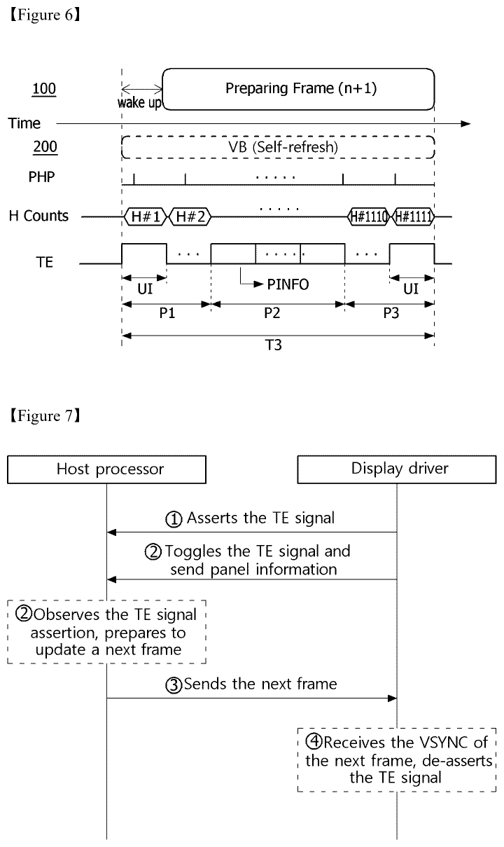

FIG. 5 is a waveform diagram showing the interrupt signal according to an embodiment of the present disclosure. In FIG. 5, “Frame n” denotes nth frame data of an image signal and “Frame (n+1)” denotes n+1th frame data of the image signal. FIG. 6 is a detailed waveform diagram showing the interrupt signal period in FIG. 5. FIG. 7 is a diagram showing operations in each duration of the display driver and the host processor during the interrupt signal period in FIG. 5.

Referring to FIG. 5 to 7, when the refresh rate is lowered in the video mode, the vertical blank period VB is extended. During the extended vertical blank period VB, the host processor 100 waits in a low-power mode with little power consumption, and the display driver 200 generates a panel charging signal PHP in order to control the self-refresh timing of pixels during the extended vertical blank period VB. Pulses of the panel charging signal PHP may be generated at a cycle of 1 horizontal period during the extended vertical blank period VB and the self-refresh timings of the pixels may be controlled to a cycle of 1 horizontal period. The gate driver may output a gate pulse for self-refresh in response to a shift clock generated based on the panel charging signal PHP.

In the video mode, the display driver 200 may generate the interrupt signal TE during the interrupt signal period T3 set within the extended vertical blank period VB at a low refresh rate. The interrupt signal TE includes a header part toggled at a cycle of a predetermined unit time UI, an information section in which the panel information PINFO is encoded, and a tail part toggled at a cycle of the unit time UI.

The interrupt signal period T3 may be divided into a first period P1 in which the header part of the interrupt signal TE is transmitted to the host processor 100, a second period P2 in which the information section including the panel information PINFO is transmitted to the host processor 100, and a third period P3 in which the tail part is transmitted to the host processor 100. The unit time UI may be n horizontal period.

As shown in FIGS. 5 and 7, the display driver 200 outputs the interrupt signal TE at an activation level when the interrupt signal period T3 is started (\textcircled{1} Asserts the TE signal). Subsequently, the display driver 200 toggles the interrupt signal TE two or more times and transmits the pulse or impulse to the host processor 100 during the first period P1 of the interrupt signal period T3, and then transmits the panel information PINFO to the host processor 100 during the second period P2 (\textcircled{2} Toggles the TE signal every horizontal period and send panel information). Subsequently, the display driver 200 may toggle the interrupt signal TE two or more times and transmit the pulse or impulse to the host processor 100 during the third period P3 of the interrupt signal period T3.

The host processor 100 wakes up in response to the activation level of the interrupt signal TE received from the display driver 200 and prepares to transmit next frame data of the image signal, for example, n+1th frame data Frame(n+1) while counting 1 horizontal period (2) Observes the TE signal assertion, prepares to update a next frame). In such a case, the host processor 100 generates pixel data of the next frame data by applying the panel information. For example, the host processor 100 may adjust the number of horizontal line data in the next frame data according to refresh rate information of the display panel, modulate the pixel data by adding a compensation value to the pixel data of the next frame data or multiply the pixel data of the next frame data by the compensation value, or spread data to be written to a defective subpixel to surrounding pixels adjacent to the defective subpixel.

The host processor 100 may transmit the n+1th frame data Frame(n+1) to the display driver 200 together with the vertical synchronization signal VSYNC when the next frame data is prepared in the video mode, and invert the interrupt signal TE to a deactivation level when the vertical synchronization signal VSYNC is detected in the received signal (3 Sends the next frame, 4 Receives the VSYNC of the next frame, de-asserts the TE signal). The vertical synchronization signal VSYNC may include vertical sync data VS, vertical back porch (VBP) data, and vertical front porch (VFP) data.

When the time for transmitting the pulse or impulse of the header part of the toggled interrupt signal TE appropriately increases, the host processor 100 may secure enough time to wake up and prepare next frame data.

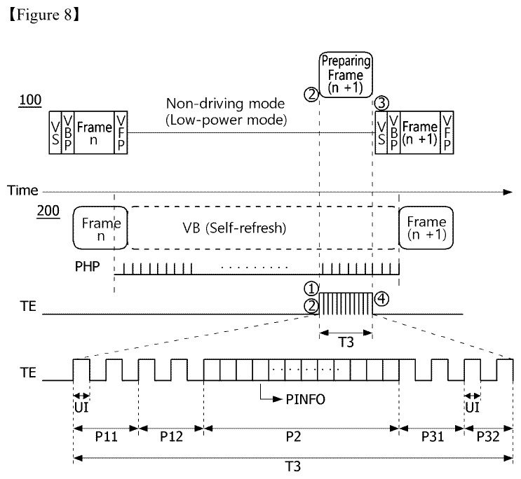

The display driver 200 counts the panel charging signal PHP in order to generate the self-refresh timing of pixels in parts per 1 pixel line during the vertical blank period. In FIG. 8, the horizontal period count H Counts may be used to define the active interval and the vertical blank period every frame period by counting a horizontal period H#1 to H#1111 of the panel charging signal PHP.

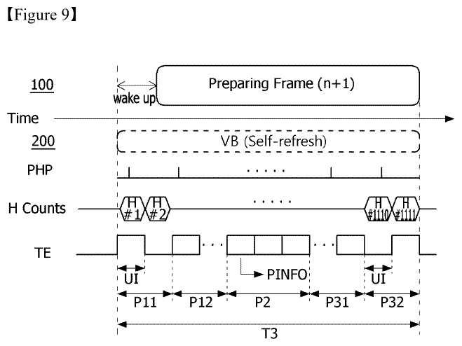

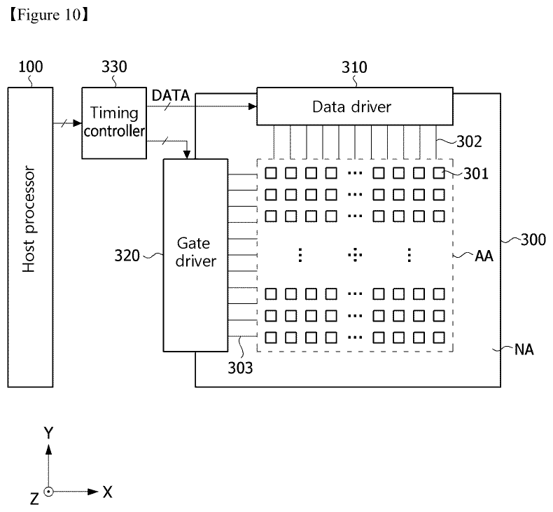

FIG. 8 is a waveform diagram showing an interrupt signal according to another embodiment of the present disclosure. FIG. 9 is a detailed waveform diagram showing an interrupt signal period shown in FIG. 8. In FIGS. 8 and 9, descriptions that overlap the embodiment shown in FIGS. 5 to 7 described above are omitted.

Referring to FIGS. 7 to 9, the display driver 200 may generate an interrupt signal TE during an interrupt signal period T3 set within the vertical blank period VB. The interrupt signal TE includes a header part that is at least partially toggled at a cycle of the predetermined unit time UI, the panel information PINFO, and a tail part that is at least partially toggled at a cycle of the unit time UI.

The header part may include a first header part toggled at a cycle of the unit time UI, for example, a cycle of n horizontal period, and a second header part indicating information on an information section in which the panel information PINFO is encoded, for example, a data length. The first header part may be placed in front of the second header part, but is not limited thereto. The tail part may include a first tail part including an error check code and a second tail part toggled at a cycle of the unit time UI. The first tail part may be placed in front of the second tail part, but is not limited thereto.

The interrupt signal period T3 may be divided into a 1-1th period P11 in which the first header part of the interrupt signal TE is transmitted to the host processor 100, a 1-2th period P12 in which the second header part is transmitted to the host processor 100, a second period P2 in which the information section including the panel information PINFO is transmitted to the host processor 100, a 3-1th period P31 in which the first tail part is transmitted to the host processor 100, and a 3-2th period P32 in which the second tail part is transmitted to the host processor 100.

FIG. 10 is a diagram showing a display device according to an embodiment of the present disclosure.

Referring to FIG. 10, the display device according to an embodiment of the present disclosure includes a display panel 300 and a display panel driving circuit for writing source data into pixels of the display panel 300.

A substrate of the display panel 300 may be a plastic substrate, a thin glass substrate, or a metal substrate, but is not limited thereto. The display panel 300 may be a panel with a rectangular structure having a length in the first direction X, a width in the second direction Y, and a thickness in the third direction Z, but is not limited thereto.

A display area AA of the display panel 300 includes a pixel array that displays an input image. The pixel array includes a plurality of data lines 302, a plurality of gate lines 303 crossing the data lines 302, and pixels 301 connected to the data lines 302 and the gate lines 303. Each of the pixels 301 may be divided into a red subpixel, a green subpixel, and a blue subpixel for color reproduction. Each of the pixels may further include a white subpixel.

Subpixels arranged in 1 pixel line may share the gate line 303, and subpixels arranged in the column direction Y along a data line direction may share the same data line 302. Pixel lines may be interpreted as horizontal lines. 1 horizontal period is the time obtained by dividing 1 frame period by the total number of pixel lines (or horizontal lines).

In an OLED display, each of the subpixels may include a light-emitting element such as an OLED. Each of the subpixels includes a pixel circuit for driving a light-emitting element. The pixel circuit may include a plurality of transistors and a storage capacitor.

As the transistor in the pixel circuit, an oxide thin film transistor (TFT) having a low leakage current may be applied. In such a case, in the oxide TFT, the power consumption of the display panel 100 may be reduced due to a low leakage current, and when a variable refresh rate is applied, a variation in the luminance of pixels is reduced at a low refresh rate, so that flicker visibility may be improved.

Pixel data of an input image may be written (or addressed) to subpixels arranged in 1 pixel line during 1 horizontal period. In such a case, a data voltage corresponding to the pixel data of the image signal may be charged in the storage capacitor of the pixel circuit within 1 horizontal period. During the extended vertical blank period with no input image, subpixels arranged in 1 pixel line may be self-refreshed with a data voltage of a previous frame charged in the storage capacitor in response to a gate pulse.

The display panel driving circuit writes the pixel data (or source data) of the input image to the pixels of the display panel 300 under the control of a timing controller 330. The display panel driving circuit includes a data driver 310 that converts the pixel data into a data voltage, and a gate driver 320.

The data driver 310 receives pixel data of an input image received as a digital signal from the timing controller 330 and outputs a data voltage. The data driver 310 may convert an input digital signal into a grayscale voltage (or gamma compensation voltage) by using a digital to analog converter (hereinafter, referred to as “DAC”), and output a data voltage. The data voltage of the pixel data may be output as a grayscale voltage corresponding to a grayscale value of the pixel data.

The data driver 310 may be integrated into an integrated circuit (IC). The timing control part 330 and the data driver 310 may be integrated together into an IC. The IC including the data driver 310 or the data driver 310 and the timing control part 330 may be interpreted as the display driver 200 described above.

The display panel driving circuit may further include a touch sensor driver for driving touch sensors. The touch sensor driver may be integrated into the display driver together with the data driver 310.

The display driver may be directly bonded to the substrate of the display panel 300 in a chip on glass (COG) or a chip on plastic (COP) process, and electrically connected to the display panel 300. The display driver may be mounted on a flexible film of a chip on film (COF), and the COF may be bonded to the display panel 300.

A circuit of the gate driver 320 may be disposed in a non-display area NA outside the display area AA in the display panel 300, or at least a portion of the circuit may be disposed in the display area AA. The gate driver 320 may be integrated into a separate gate driver IC and electrically connected to the gate lines 303 of the display panel 300.

The gate driver 320 sequentially outputs a gate pulse (or scan pulse) to the gate lines under the control of the timing controller 330. The gate driver 320 may shift the gate pulse by using a shift register to sequentially supply the pulse of the gate signal to the gate lines 303. The gate driver 320 may output the gate pulse in response to a shift clock received from the timing controller 330 or the display driver 200 through a level shifter.

The timing controller 330 may receive the pixel data of the input image signal and a timing signal synchronized with the pixel data from the host processor 100. The timing controller 330 may transmit the pixel data of the image signal to the data driver 310 and control the operation timings of the display panel driving circuits 310 and 320.

The objects to be achieved by the present disclosure, the means for achieving the objects, and effects of the present disclosure described above do not specify essential features of the claims, and thus, the scope of the claims is not limited to the disclosure of the present disclosure.

Although the embodiments of the present disclosure have been described in more detail with reference to the accompanying drawings, the present disclosure is not limited thereto and may be embodied in many different forms without departing from the technical concept of the present disclosure. Therefore, the embodiments disclosed in the present disclosure are provided for illustrative purposes only and are not intended to limit the technical concept of the present disclosure. The scope of the technical concept of the present disclosure is not limited thereto. Therefore, it should be understood that the above-described embodiments are illustrative in all aspects and do not limit the present disclosure.

### Industrial Applicability

The present invention can be applied to a digital high-speed interface between a host processor and a display driver.

1. A transmission and reception control method comprising:
a step in which, in a first mode, after a first interrupt signal is received from a reception device, a transmission device transmits an image signal to the reception device together with a synchronization signal; and
a step in which, in a second mode, after a second interrupt signal is received from the reception device, the transmission device transmits an image signal to the reception device without a synchronization signal,
wherein at least one of the first interrupt signal and the second interrupt signal comprises panel information to be applied to pixel data of the image signal.

2. The transmission and reception control method of claim 1, wherein the panel information comprises one or more information of a compensation value to be applied to the pixel data of the image signal, location information of a defective subpixel, a refresh rate of a display panel, a bandwidth of the image signal, an interrupt signal period, and the number of pixel lines of the display panel.

3. The transmission and reception control method of claim 1, further comprising:
a step in which, in the first mode, the transmission device waits in a non-driving state during a vertical blank period until the first interrupt signal is detected, and wakes up and transmits next frame data to the reception device when the first interrupt signal is detected, and
a step in which, in the second mode, a synchronization signal is generated inside the reception device.

4. The transmission and reception control method of claim 1, wherein at least one of the first interrupt signal and the second interrupt signal comprises at least one of a header part and a tail part, and
at least one of the header part and the tail part comprises a pulse toggled at a cycle of n (n is a positive integer) horizontal period and having a pulse width of n horizontal period, or two or more impulses generated at a cycle of n horizontal period.

5. The transmission and reception control method of claim 4, wherein at least one of the first interrupt signal and the second interrupt signal comprises the header part, an information section in which the panel information is encoded, and the tail part, and an interrupt signal period during which at least one of the first interrupt signal and the second interrupt signal is transmitted to the transmission device comprises:
a first period during which the header part is transmitted to the transmission device;
a second period during which the information section is transmitted to the transmission device; and
a third period during which the tail part is transmitted to the transmission device.

6. The transmission and reception control method of claim 1, wherein at least one of the first interrupt signal and the second interrupt signal comprises:
a first header part toggled at a cycle of n (n is a positive integer) horizontal period;
a second header part comprising information on an information section in which the panel information is encoded;
a first tail part comprising an error check code; and
a second tail part toggled at a cycle of n horizontal period,
an interrupt signal period during which at least one of the first interrupt signal and the second interrupt signal is transmitted to the transmission device comprises:
a 1-1th period during which the first header part is transmitted to the transmission device;
a 1-2th period during which the second header part is transmitted to the transmission device;
a second period during which the information section in which the panel information is encoded is transmitted to the transmission device;
a 3-1th period during which the first tail part is transmitted to the transmission device; and
a 3-2th period during which the second tail part is transmitted to the transmission device.

7. The transmission and reception control method of claim 1, wherein the first mode is a video mode of a mobile industry processor interface (MIPI),
the second mode is a command mode of the MIPI,
the transmission device comprises one of a system on chip (SoC), an application processor (AP), and a graphics processing part (GPU), and
the reception device comprises a display driver that outputs data of the image signal and outputs a display timing signal.

8. A display driver comprising:
an interrupt signal generation part that transmits an interrupt signal to a host processor through an interrupt signal line within a vertical blank period in each of a first mode and a second mode;
a reception part that receives data of an image signal from the host processor through a data lane together with a synchronization signal in the first mode, and receives the data of the image signal through the data lane without the synchronization signal in the second mode; and
a display control part that generates a display timing signal based on the synchronization signal received from the host processor and outputs the data of the image signal in the first mode, and generates the display timing signal based on an internally generated synchronization signal and outputs the data of the image signal in the second mode,
wherein the interrupt signal comprises panel information to be applied to pixel data of the image signal.

9. The display driver of claim 8, wherein the interrupt signal comprises one or more of a header part transmitted to the transmission device before an information section including the panel information and a tail part transmitted to the transmission device after the information section,
one or more of the header part and the tail part comprise a signal toggled at a cycle of n (n is a positive integer) horizontal period, and
an interrupt signal period during which the interrupt signal is transmitted to the host processor comprises:
a first period during which the header part is transmitted to the host processor;
a second period during which the information section is transmitted to the host processor; and
a third period during which the tail part is transmitted to the host processor.

10. The display driver of claim 8, wherein the interrupt signal comprises:
a first header part toggled at a cycle of n (n is a positive integer) horizontal period;
a second header part comprising information on an information section in which the panel information is encoded;
a first tail part comprising an error check code; and
a second tail part toggled at a cycle of n horizontal period,
an interrupt signal period during which the interrupt signal is transmitted to the host processor comprises:
a 1-1th period during which the first header part is transmitted to the host processor;
a 1-2th period during which the second header part is transmitted to the host processor;
a second period during which the information section in which the panel information is encoded is transmitted to the host processor;
a 3-1th period during which the first tail part is transmitted to the host processor; and
a 3-2th period during which the second tail part is transmitted to the host processor.
